(19) United States
(12) Patent Application Publication
(10) Pub. No.: US 2012/0167339 A1
(43) Pub. Date: Jul. 5, 2012

(54) Device For Discreet and Unobstructed Outdoor Observation

(75) Inventor: Tony Uno, Apache Junction, AZ (US)

(73) Assignee: INNOVATIVE PRODUCTS OPERATIONS, INC., Apache Junction, AZ (US)

(21) Appl. No.: 12/981,341

(22) Filed: Dec. 29, 2010

(51) Int. Cl. E06B 7/28; B23P 11/00; B23P 17/00; E06B 7/16

(52) U.S. Cl. 16/2.1; 29/701; 29/426.2

(57) ABSTRACT

A device for discreet unobstructed outdoor observation can be attached to a window screen to allow for unobstructed viewing of the outdoors. Prior to attachment to the window screen, a portion of the window screen is cut away to expose a viewing area. The device is then positioned over the viewing area. A cap can be placed on the device when not in use. Preferably, a kit is provided including instructions, a template for cutting away a portion of the window screen at a desired location, and the viewing device.

### FIELD OF THE INVENTION

The present invention relates to the field of viewing devices, and, more particularly, to a device for observing outdoor environments in a discreet manner.

### BACKGROUND

It is often desirable to be able to view the outdoors without being observed. For example, one might own a country estate that is frequented by wildlife such as colorful birds and deer. While it is possible to peer out the window to view these creatures without disturbing them, often the window will have a screen which impedes viewing.

Furthermore, for security purposes, it may be necessary to discreetly observe objects and persons situated outside. There are devices on many doors allowing the homeowner to peer through the device to ensure that the door can be safely opened. A common device for such purposes is the peephole. In many cases, a peephole includes a wide angle lens. U.S. Pat. No. 4,869,021 to Gregory adds to the conventional peephole an opening wherein a telescope can be inserted. However, this device is only for a door, not a window, and the telescope can be seen from outside.

### SUMMARY OF THE INVENTION

A device for discreet unobstructed outdoor observation can be attached to a window screen to allow for unobstructed viewing of the outdoors. Prior to attachment to the window screen, a portion of the window screen is cut away to expose a viewing area. The device is then positioned over the viewing area. A cap can be placed on the device when not in use. Preferably, a kit is provided including instructions, a template for cutting away a portion of the window screen at a desired location, and the viewing device.

According to preferred embodiments of the present invention, the device is structured and arranged to comprise a first ring, the first ring including a first threaded portion, and a second ring, the second ring including a second threaded portion. When the device is assembled and used, the first ring and the second ring are placed onto respective opposite sides of the window screen, and then threadably attached. Preferably, the first threaded portion and the second threaded portion are complementarily threaded, most preferably, the first threaded portion includes external threading and the second threaded portion includes complementary internal threading.

Preferably, the first ring further includes a cap retaining portion. Preferably, the viewing device further includes a cap, the cap attachable to the cap retaining portion.

In various preferred embodiments, the first ring further includes a mounting ring retaining portion. Preferably, a mounting ring is attachable to the mounting ring retaining portion. Preferably, the mounting ring includes a V-shaped mount to facilitate mounting of a camera, telescope, firearm, etc.

These and other aspects, features, and advantages of the present invention will become apparent from the following detailed description of preferred embodiments, which is to be read in connection with the accompanying drawings.

### BRIEF DESCRIPTION OF THE DRAWINGS

FIG. 1 shows an exemplary viewing device attached to a window screen for discreet unobstructed observation of the outdoors, according to preferred embodiments of the present invention;

FIG. 2 shows a close-up perspective view of the viewing device;

FIG. 3 shows a close-up side view of the viewing device;

FIG. 4 shows an exploded view of viewing device;

FIG. 5 shows an exemplary template for preparing a window screen for use of the viewing device, according to preferred embodiments of the present invention; and

FIG. 6 shows the exemplary template being used on an exemplary window screen.

### DETAILED DESCRIPTION

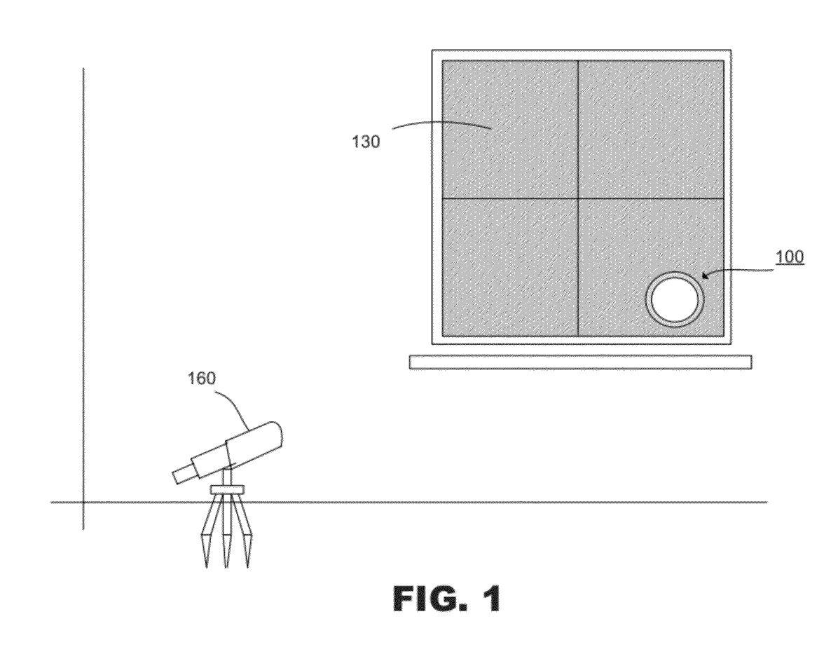

FIG. 1 illustrates an exemplary viewing device 100 attached to a window screen 130 for discreet unobstructed observation of the outdoors. Preferably, and as shown, the exemplary viewing device 100 is circular; however, the viewing device 100 could, alternatively, be another shape, e.g., ovular, rectangular. As will be described in greater detail, preparatory to placement of the exemplary viewing device 100 onto the window screen 130, preferably, a portion of the window screen 130 corresponding in shape and size to the exemplary viewing device 100 is cut away. Then, the exemplary viewing device 100 is attached to the window screen 130, as shown.

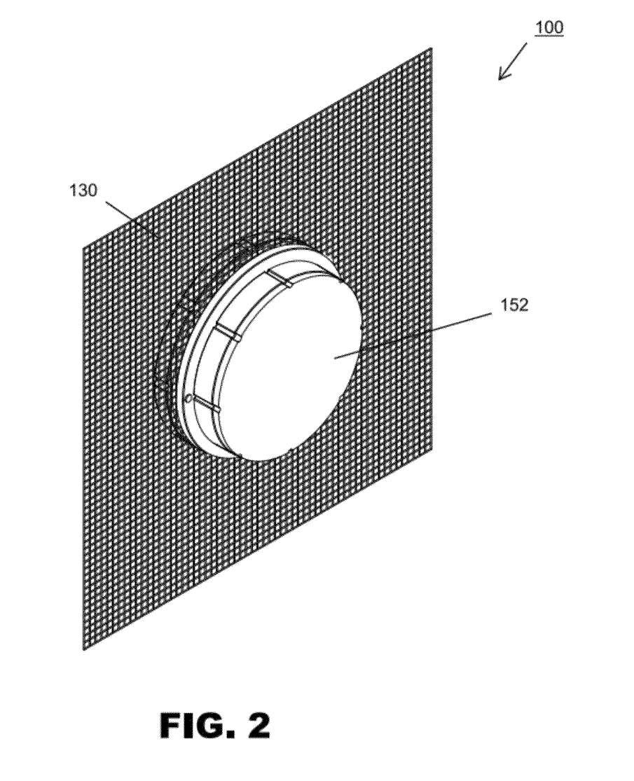

When not in use, a cap 152 (shown in FIG. 2) can optionally be placed onto the viewing device 100. The exemplary viewing device 100 can be accessed whenever a user wants to discreetly observe the outdoors. By way of example, a user might wish to observe the outdoors using a telescope 160. In this case the user would simply remove the cap 152 (if it is on), position the telescope 160 to see through the viewing device 100, and then peer into the telescope 160 to obtain an unobstructed view of the outdoors. Alternately, the user could use another visual aid (such as binoculars) or just look out with the naked eye.

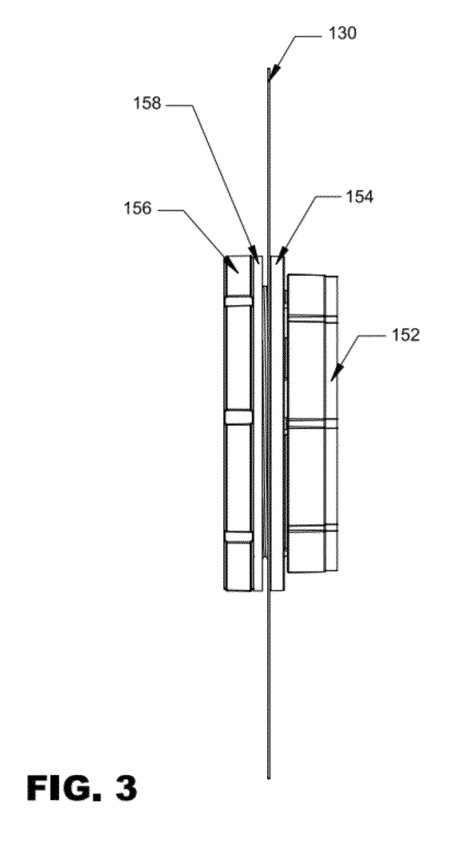

Referring to FIG. 3, a close-up side view of the exemplary viewing device 100 is shown. As depicted in FIG. 3, the exemplary viewing device 100 includes a first ring 156 and second ring 154 that are placed onto respective opposite surfaces of the window screen 130. The exemplary viewing device 100 is assembled upon the window screen 130 by screwing together the first ring 156 and the second ring 154, with the window screen 130 situated therebetween, as shown. Preferably, the first ring 156 includes a first threaded portion and the second ring 154 includes a second complementarily threaded portion. Also shown in FIG. 3 is a third ring 158 that acts, preferably, as a washer. On the inside surface of the window screen 130, preferably, the exemplary viewing device 100 includes the cap 152 which can be utilized when the device is not in use.

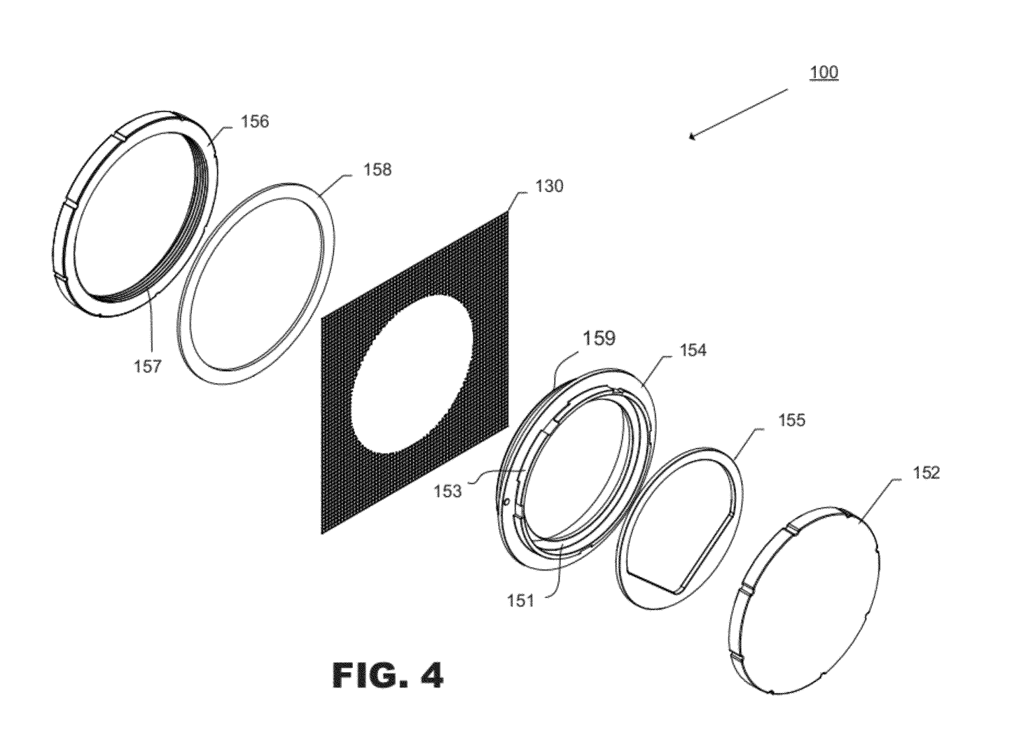

FIG. 4 shows an exploded view of the exemplary viewing device 100, according to a preferred embodiment of the present invention. As depicted, the first ring 156 includes an internally threaded portion 157 and the second ring 154 includes an externally threaded portion 159, the first ring 156 and the second ring 154 threadably attachable. As depicted, the second ring 159 also includes, on an opposite side thereof, a mounting ring retaining portion 151 and a cap retaining portion 153. A mounting ring 155 can be frictionally fitted into the mounting ring retaining portion 151. Preferably, the mounting ring 155 includes a V-shaped mount useable for mounting a camera, firearm, etc. The cap 152 can be attached to the cap retaining portion 152 by friction fitting it to the cap retaining portion 153.

Preferably, the viewing device 100 is made from a hard durable plastic such as Acrylonitrile Butadiene Styrene (ABS) or Polyvinyl Chloride (PVC). Preferably, the components of the present invention are each injection molded or produced using another suitable process. Preferably, the viewing device 100 will be available in various different sizes (e.g., 4-inch and 6-inch models). Preferably, the viewing device 100 will be produced in a solid color (e.g., gray, brown, black) to blend with the window screen. However, the viewing device 100 could also be made in various camouflage patterns and/or other colors.

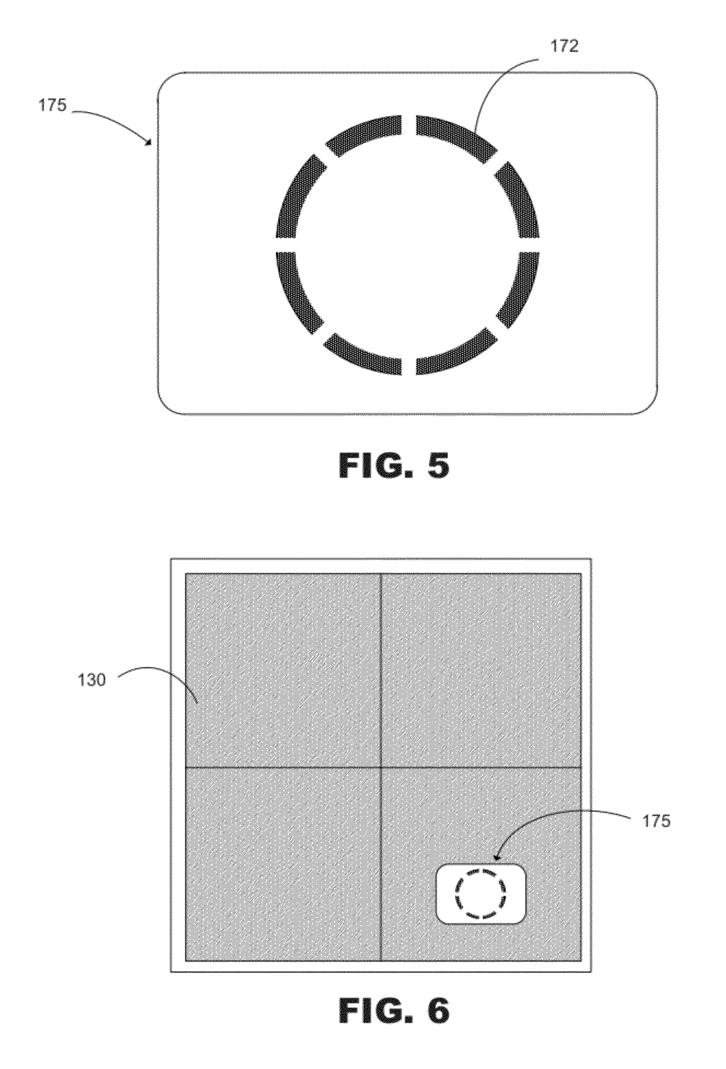

FIG. 5 shows an exemplary template 175 for preparing the window screen 130 for use with the viewing device 100, according to a preferred embodiment of the present invention. FIG. 6 shows the exemplary template 175 being placed on the window screen 130. Preferably, the template 175 is made from a substantially flat, flexible material such as paper having a pressure-sensitive adhesive on a side thereof. In operation, the user presses the template 175 onto a desired area of the window screen 130 where the viewing device 100 will be placed. Then, the user uses a cutting instrument, such as a utility razor or an X-AXACTO knife, to carefully cut away a portion of the screen by following along the dashed line 172 with the cutting instrument. According to a preferred embodiment of the present invention, a kit is provided including a set of directions for applying the template 175 to the window screen 130 and assembling the viewing device 100 upon the window screen 100.

It is to be understood that the present invention is intended to be used solely for legal purposes. Furthermore, it is to be understood that nothing in the present disclosure is meant to encourage unlawful use (misuse) of the present invention.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A viewing device for viewing the outdoors, comprising:
a first ring, the first ring including a first threaded portion; and
a second ring, the second ring including a second threaded portion;
wherein, when the viewing device is assembled and used on a prepared screen, the first ring and the second ring are placed onto respective opposite sides of the screen and threadably attached.

2. The viewing device of claim 1, wherein the first threaded portion and the second threaded portion are complementarily threaded.

3. The viewing device of claim 2, wherein the first threaded portion includes external threading and the second threaded portion includes internal threading.

4. The viewing device of claim 1, wherein the prepared screen is prepared by removing a portion of the screen.

5. The viewing device of claim 1, wherein the first ring further includes a cap retaining portion.

6. The viewing device of claim 5, further including a cap, the cap attachable to the cap retaining portion.

7. The viewing device of claim 1, further including a third ring, the third ring situate between the first ring and the second ring when the viewing device is assembled.

8. The viewing device of claim 7, wherein the third ring is a washer.

9. The viewing device of claim 1, wherein the first ring further includes a mounting ring retaining portion.

10. The viewing device of claim 7, further including a mounting ring, the mounting ring attachable to the mounting ring retaining portion.

11. The viewing device of claim 8, wherein the first ring is situate between the third ring and the mounting ring.

12. The viewing device of claim 8, wherein the mounting ring includes a V-shaped mount.

13. The viewing device of claim 1, wherein the first ring and the second ring are substantially circular.

14. The viewing device of claim 1, wherein the first ring and the second ring are substantially ovular.

15. The viewing device of claim 1, wherein the first ring and the second ring are substantially rectangular.

16. A kit for assembling a viewing device for viewing the outdoors, comprising:
a template comprising an adhesive-backed material having an outline thereupon;
the viewing device of claim 1; and
instructions for using the template to cut away a portion of the window screen to accommodate the viewing device and assembling the viewing device.

17. A method for installing a viewing device, comprising:
in accordance with the instructions provided in the kit of claim 16,
placing the template provided in the kit of claim 16 upon a window screen at a desired location;
following along the outline, cutting the window screen to form a viewing area; and
assembling the viewing device provided in the kit of claim 16 and placing it upon the window screen so that the viewing area is substantially unimpeded.
